(19) United States
(12) Patent Application Publication
(10) Pub. No.: US 2012/0278166 A1
(43) Pub. Date: Nov. 1, 2012

(54) Cognitive Relevance Targeting in a Social Networking System

(76) Inventors: Gregory Badros, (US); Rajat Raina, (US); Hong Ge, (US); Ding Zhou, (US); Nuwan Senaratna, (US); Tudor A. Alexandrescu, (US)

(21) Appl. No.: 13/095,899

(22) Filed: Apr. 28, 2011

(51) Int. Cl. G06Q 30/02; G06F 15/16

(52) U.S. Cl. 705/14.53; 709/204

(57) ABSTRACT

A social networking system infers a user's present interests based on the user's recent actions and/or the recent actions of the user's connections in the social networking system. The social networking system also determines a set of concepts associated with each of a set of information items, such as advertisements. By matching the user's present interests with the concepts associated with the information items, the social networking system selects one or more of the information items that are likely to be of present interest to the user. The social networking system then presents the selected information items for display to the user, thereby providing information based on an inferred temporal relevance of that information to the user.

### BACKGROUND

This invention relates generally to social networking, and in particular to providing information items, including advertisements, to users of a social networking system based on the inferred temporal relevance of that information to the users.

Social networking systems allow users to connect to and form relationships with other users, contribute and interact with media items, use applications, join groups, list and confirm attendance at events, create pages, and perform various other tasks that facilitate social interaction. A social networking system therefore provides information to its users in a number of different contexts. For example, a social networking system may provide updates about the actions of a user's connections (i.e., a newsfeed story), search results, content recommendations, and a variety of other types of information items. Typically, the social networking system selects one or more information items from a larger set of candidate information items for display to a user. For example, a social networking system may present advertisements to a user, selecting one or more advertisements for the user based on targeting criteria associated with the advertisements and on various attributes of the user.

One difficulty facing social networking systems when selecting information items to provide their users is that a user's actual current interests may change over time much more quickly compared to the information used to select the relevant information items to display. The result is that advertisements and other information items that are less relevant to the user at a given point in time will often be selected for presentation to the user, and these information items will thus tend to receive less of the user's attention. For advertisements, this results in lower conversion rates and thus less advertising revenue. Similarly, other information items such as newsfeed updates that are less interesting or relevant to a user at a particular point of time lead to a less optimal user experience that fails to maximize user engagement with the social networking system.

### SUMMARY

To provide more relevant information items (such as advertisements) to a user of a social networking system, embodiments of the invention select information for display to the user based on the inferred temporal relevance of that information to the user. In one embodiment, a social networking system infers a user's current interests based on the user's recent actions and/or the recent actions of the user's connections. The social networking system also determines a set of concepts associated with each of a set of information items. By matching the user's current interests with the concepts associated with the information items, the social networking system selects one or more of the information items that are likely to be of present interest to the user. The social networking system then presents the selected information items for display to the user.

In one embodiment, the social networking system infers a user's current interests by extracting a set of concepts from the user's recent actions, and optionally from the recent actions of the user's connections. These concepts are then weighted (or discounted) based on a number of factors, which may include the time since the action was performed, the type of the action, whether the action was performed by the user or the user's connection (and if so, the closeness of the connection), and how closely in a taxonomy the concept matches a tag word or label associated with the action. In this context, more recent actions are typically given greater importance, and different actions may be weighted differently. For example, a user's commenting on a news story may initially be given more importance than the user's joining a group, but the action of commenting may decay more quickly than the joining of the group. The taxonomy enables the system to infer additional interests from a smaller set of labels, but these are generally discounted as the words are further apart in the taxonomy. For example, if a user checks in at a Starbucks, the system may infer the concept of “Starbucks” as one interest and the concept of “coffee” as another interest, but one that is discounted due to its distance from the original “Starbucks” label associated with the check-in action.

Similarly, the social networking system may weight (or discount) the concepts that it determines for each of the information items. These concepts may be obtained from tag words and other metadata associated with the information items, as well as from the content of the information items themselves. For an advertisement, for example, the concepts may include tag words, targeting criteria, advertisement content, and the content of pages pointed to by links in the advertisement. The set of concepts determined for an information item may be expanded by reference to a taxonomy in which additional concepts related to the identified concepts are added to the set. As above, these additional inferred concepts from the taxonomy may be discounted based on their distance from the originally identified concepts. In one embodiment, once the concepts associated with the user's inferred interests and the concepts for each of the information items are determined, a fuzzy matcher determines one or more matching information items based on the overlap of the concepts and their respective weights.

The information items may comprise advertisements, wherein embodiments of the invention are used to provide temporally relevant advertising to a user. In other embodiments, the information items may include newsfeed stories, notifications, invitations, or any other type of information that may be selected for presentation to a user of an online system. Embodiments of the invention may have a particular utility in a social networking system, which may leverage its knowledge about the actions of the user's connections to infer additional information about the user's current interests. However, other embodiments need not use information about a user's connections and may thus be useful in other types of online systems that select information for presentation to a user.

### BRIEF DESCRIPTION OF THE DRAWINGS

FIG. 1 is a diagram of a process for targeting information items to users of a social networking system, in accordance with an embodiment of the invention.

FIG. 2 is a diagram of the overall system environment for targeting information items to users of a social networking system, in accordance with an embodiment of the invention.

FIG. 3 depicts an example taxonomy used by the action interest extractor and information item concept extractor.

FIG. 4 is a table of a set of example concepts and their associated discount factors for representing a user's inferred interests, in accordance with an embodiment of the invention.

FIG. 5 is an example of an advertisement in a social networking system, in accordance with an embodiment of the invention.

FIG. 6 is a table of a set of example concepts and their associated cumulative discount factors determined for an advertisement information item, in accordance with an embodiment of the invention.

FIG. 7 illustrates a process for targeting advertisements to a user based on the inferred temporal relevance of the advertisements to the user's current interests, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Process for Targeting Based on Contextual Relevance

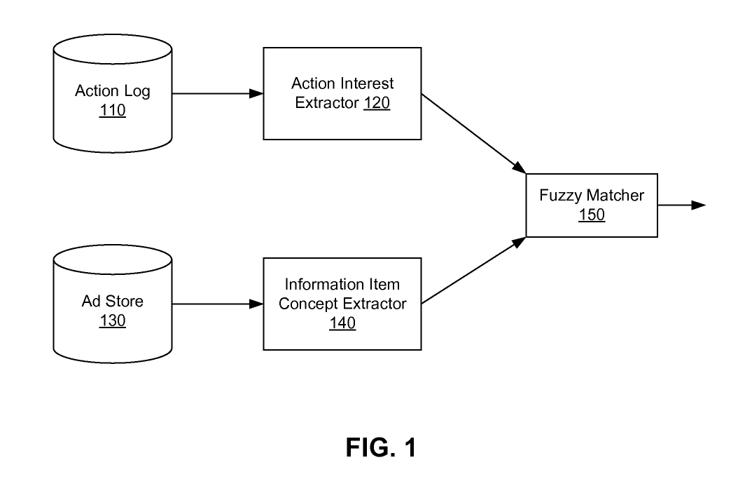

FIG. 1 is a high level diagram of a process flow for targeting information items to users of a social networking system based on the inferred temporal relevance of the advertisements to the user's current interests. These information items may include advertisements, newsfeed stories, notifications, invitations, or any other type of information that may be selected for presentation to a user of an online system. In the example of FIG. 1, the information items comprise advertisements hosted on the ad store 130.

The action log 110 stores a log of actions of a user and those of other users with whom the user has established a connection in the social networking system (i.e., the user's connections). A log entry for an action may include the time of occurrence of the action, a type of action performed, the user who performed the action, an object on which the action was performed, and any other information related to the action, such as the content of a user's comment or a location associated with the action. For example, in the action ‘Adrian bought a ring at Tiffany & Co.,’ the type of action is buying, the object is a ring and extra information includes where the ring was bought, Tiffany & Co. The actions may be taken online either within the social networking system or outside of it, or they may be actions performed in the real world and recorded and communicated to the social networking system. The action log 110 provides the logs of actions and times to the action interest extractor 120.

The action interest extractor 120 extracts interests for each of the actions and weights or discounts the actions based in part on a time associated with the actions. An extracted interest may be expressed as a term that describes information about the action. For example, for the action ‘Charlie joined the group SF Foodies,’ the action interest extractor 120 may extract interests such as “food,” “cooking,” and “San Francisco,” since these terms reflect information about the action. Moreover, the weighting (or discounting) of these interests enables the system to assign more meaning to certain interests. For example, interests associated with more recent actions may be weighted higher because they are more likely to represent the user's state of mind, and interests associated with actions performed by the user may be weighted more heavily than interests associated with actions performed by the user's friends. In one embodiment, the action interest extractor 120 may extract information describing user actions as the user performs the actions, for example, as the user interacts with the social networking system via a client device. Alternatively, the action interest extractor 120 may extract information describing past user actions stored in action logs 110 as an offline operation. Because of the dynamic nature of the action log 110 relative to a user, it can be appreciated that the extracted interests and their weights will change over time, just as a user's current interests can change. The action interest extractor 120 provides the extracted weighted interests to the fuzzy matcher 150.

The ad store 130 stores or otherwise has access to a plurality of advertisements. Each advertisement may include content (such as a title, text, image, and a link) and may be associated with metadata such as targeting criteria. For a particular user that is to be shown an advertisement, an ad system may apply the targeting criteria to determine a set of candidate advertisements from the ad store 130 to provide to the user. The ad store provides these candidate advertisements and their associated metadata to an information item concept extractor 140, which then extracts concepts that represent each of these advertisements. As with the concepts extracted from the action log 110, the concepts extracted from each advertisement reflect information about the advertisement. For advertisements, for example, the information item concept extractor 140 may extract concepts based on the content of the advertisement, its targeting criteria, and/or information contained within a page or other content item associated with a link in the advertisement. For example, an advertisement that mentions a restaurant and contains a link to the restaurant's web page, the extracted concepts for the advertisement may include the name of the restaurant and the style of food mentioned in the web page. The information item concept extractor 140 then provides the concepts for each of a set of advertisement to the fuzzy matcher 150.

Using the set of interests that describe the user's current state of mind and the sets of concepts that describe each candidate advertisement, the fuzzy matcher 150 attempts to select one or more advertisements that best matches the user's current interests. In one embodiment, the fuzzy matcher 150 takes the action interests and the information item concepts as inputs and then outputs a set of features that can be used in CTR prediction and ranking for a system that selects content items for a user (such as an ad server). By providing better targeted and more relevant information items to a user, the provided information may enhance the user's experience and will be less likely to annoy the user as a distraction.

### Overview of Social Networking System

A social networking system allows users to associate themselves and establish links with other users of the social networking system. When two users become linked, they are said to be “connections,” “friends,” “contacts,” or “associates” within the context of the social networking system. Generally being linked in a social networking system allows linked users access to more information about each other than would otherwise be available to unlinked users. The social networking system provides a user with various ways to communicate with other users, for example, by email (internal and external to the social networking system), instant message, text message, phone, and the like. The social networking system allows a user to introduce new content items as well as to view, comment on, download or endorse another user's content items. Examples of content items include but are not limited to messages, queued messages (e.g., email), text and SMS (short message service) messages, comments, messages sent using any other suitable messaging technique, an HTTP link, HTML files, images, videos, audio clips, documents, document edits, calendar entries or events, and other computer-related files.

Users of social networking systems may interact with objects such as content items, user profile information, user actions, or any other action or data within the social networking system. This interaction may take a variety of forms, such as by communicating with or commenting on the object; clicking a button or link associated with affinity (such as a “like” button); sharing a content item, user information or user actions with other users; or downloading or viewing a content item. Users of a social networking system may also interact with other users by connecting or becoming friends with them, by communicating with them, or by having common connections within the social networking system. Further, a user of a social networking system may form or join groups or may like a page (i.e., to express an interest in a page or other non-user entity). Finally, a social networking system user may interact with content items, websites, other users or other information outside of the context of the social networking system's web pages that are connected to or associated with the social networking system. For instance, an article on a news web site might have a “like” button that users of the social networking system may click on to express approval of the article. These interactions and any other suitable actions within the context of a social networking system are recorded in social networking system data, which may be used to display targeted and relevant information items that the user is more likely to act on, by say clicking on them.

The social networking system maintains a user profile for each user. Any action that a particular user takes with respect to another user is associated with each user's profile, through information maintained in a database or other data repository. Such actions may include, for example, adding a link to the other user, sending a message to the other user, reading a message from the other user, viewing content associated with the other user, attending an event posted by another user, among others. The user profiles also describe characteristics, such as work experience, educational history, hobbies or preferences, location or similar data, of various users and include data describing one or more relationships between users, such as data indicating users having similar or common work experience, hobbies or educational history. Users may also post messages specifically to their profiles in the form of “status updates.” Users of a social networking system may view the profiles of other users if they have the permission. In some embodiments, becoming a connection of a user automatically provides the permission to view the user's profile.

The social networking system also attempts to deliver the most relevant information items to a viewing user employing algorithms to filter the raw content on the network. Content is filtered based on the attributes in a user's profile, such as geographic location, employer, job type, age, music preferences, interests, or other attributes. A “newsfeed” is a collection of updates visible to a user when he logs into the social networking system. Newsfeed stories may be generated to deliver the most relevant information to a user based on a ranking of the generated content, filtered by the user's affinity, or attributes. Similarly, “social endorsement” information may be used to provide social context for advertisements that are shown to a particular viewing user.

The social networking system also provides application developers with the ability to create applications that extend the functionality of the social networking system to provide new ways for users to interact with each other. For example, an application may provide an interesting way for a user to communicate with other users, or allow users to participate in multi-player games, or collect some interesting information such as news related to a specific topic and display it to the user periodically. The social networking system acts as a platform for the applications. Some of the applications may reside on an external server and may be hosted by a third party.

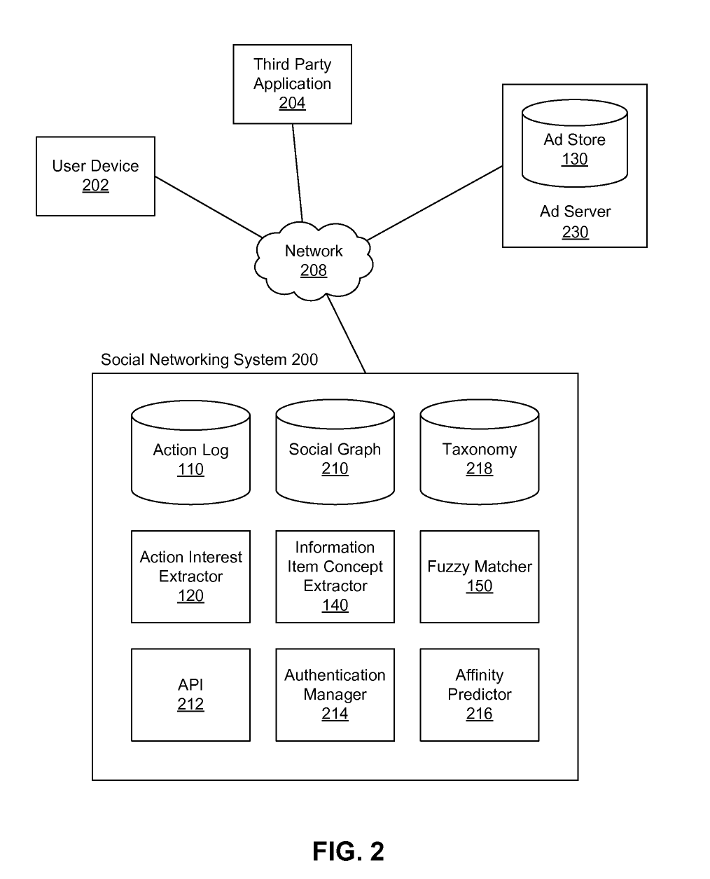

FIG. 2 is a high-level block diagram of an environment of a social networking system according to one embodiment. FIG. 2 illustrates a social networking system 200, a user device 202, a third party application 204 and ad server 230 connected by a network 208. The ad server 230 hosts the ad store 130 previously described.

A user interacts with the social networking system 200 using a user device 202, such as a personal computer or a mobile phone. The user device 202 may communicate with the social networking system 200 via an application such as a web browser or native application. Typical interactions between the user device 202 and the social networking system 200 include operations such as viewing profiles of other users of the social networking system 200, contributing and interacting with media items, joining groups, listing and confirming attendance at events, checking in at locations, liking certain pages, creating pages, and performing other tasks that facilitate social interaction.

The third party application 204, which is an application residing on an external server, may comprise a service running on a web server or an application on a mobile phone. Additionally, the third party application 204 may interact with the social networking system 200 via a system-provided application programming interface (API) 212. For example, a third party website may perform operations supported by the API, such as enabling users to send each other messages through the social networking system 200 or showing advertisements routed through the social networking system 200.

The ad server 230 resides outside the social networking system 200 in the embodiment of FIG. 2. However, the ad server 230 may reside within the social networking system 200 in other embodiments. The ad store 130 within the ad server 230 stores advertisements aimed at users of the social networking system 200 or the third party application 204. In general, the information item concept extractor 140 can process information items received from any information item server instead of the ad server 230.

The advertisements may be associated with targeting criteria that the ad server 230 uses to determine an eligible set of advertisements for a given user with specified demographic information including age, gender, and/or location. For example, the targeting criteria may specify single marital status, a high income range, and an age range in the twenties for targeting an advertisement of men's health magazines.

The social networking system 200 comprises a number of components used to store information about its users and objects represented in the social networking environment, as well as the relationships among the users and objects. The social networking system 200 additionally comprises components to enable several actions for client devices accessing the system, as described above.

The authentication manager 214 authenticates a user on user device 202 as belonging to the social graph on the social networking system 200. It allows a user to log into any user device that has an application supporting the social networking system 200. In some embodiments, the API 212 works in conjunction with the authentication manager 214 to validate users on the third party application 204.

The social networking system 200 further comprises a social graph 210. The social graph 210 stores the connections that each user has with other users of the social networking system 200. The social graph 210 may also store second order connections, in some embodiments. If user A is a first-order connection of user B, and B is a first-order connection of C, then C is a second-order connection of A on the social graph 210. The social networking system 200 also comprises an action log, which stores information about actions that the users of the social networking system 200 have performed.

The social networking system 200 also includes an affinity predictor 216, which uses information from the social graph 210 to determine affinity between the user and the user's connections. The relationship of a connection with a user may be determined based on multiple factors, including the number and/or nature of interactions between a user and a connection and any common elements in the profiles of the user and the connection. For example, a user and a connection that interact once every week on average, as opposed to every month on average, are judged to have a stronger relationship. Similarly, if a user and a connection exchange private messages, they are judged to have a stronger relationship than if they were to exchange public messages. Additionally, if the connection and the user went to the same school, for example, as determined from the profiles of the user and the connection, the connection and the user are determined to have a strong relationship.

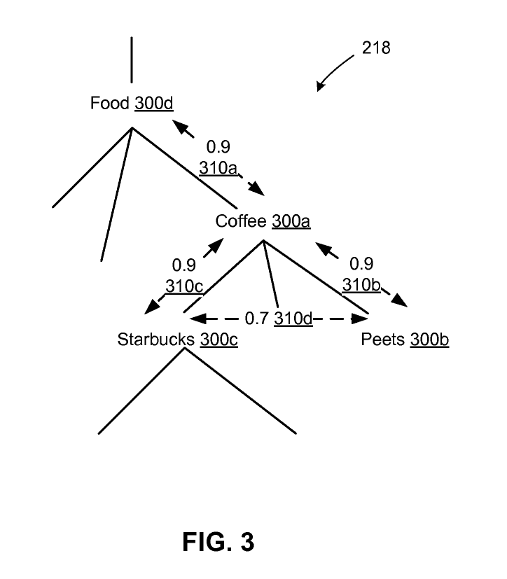

The social networking system 200 comprises a taxonomy 218 that stores a hierarchical arrangement of terms (which may include interests and/or concepts) and the relationships between the terms. FIG. 3 depicts an example taxonomy that may be used by the action interest extractor 120 and information item concept extractor 140. For the purpose of the taxonomy 218, a term refers to an entity 300 in the hierarchical arrangement. In the example of FIG. 3, the entities are Coffee 300a, Peets 300b, Starbucks 300c, and Food 300d.

The taxonomy 218 takes an interest or concept as input and provides a number of related interests or concepts from a hierarchical arrangement. In one embodiment, the related interests or concepts may comprise the immediate parent, child or sibling entities 300 in the hierarchical arrangement. As an example, when taxonomy 218 receives ‘Starbucks’ as an input interest or concept, it first locates ‘Starbucks’ in the hierarchical arrangement and provides related interests or concepts. In the example, the related interest or concepts for ‘Starbucks’, may be ‘Food’, ‘Peets’ and ‘Coffee.’ Additionally, the discount factor associated with one term may be higher for terms that are higher in the hierarchical arrangement in the taxonomy. This reflects the increased stability of terms that are higher in the hierarchical arrangement in the taxonomy as indicators of the user's interest. For example, the higher interest of coffee may be a stable interest whereas the lower specific interest of Peets may be a transient interest.

The taxonomy 218 may also provide a relatedness factor 310 associated with each additional concept or additional interest it provides as output. The relatedness factor is measure of how closely the additional concept or additional interest is related to the input concept or interest. In the example discussed earlier, the relatedness factors are Food to Coffee 310a of 0.9, Coffee to Peets 310b of 0.9, Coffee to Starbucks 310c of 0.9 and Starbucks to Peets 310d of 0.7. The relatedness factors between entities not directly connected in the hierarchy may be computed from the relatedness factors between entities connecting them. For example, in an embodiment of the invention, the relatedness factor 310 for Starbucks to Food is computed by multiplying the relatedness factors for Food to Coffee 310a and Coffee to Starbucks 310c. Additionally, in some embodiments, the taxonomies may be sparse. Intermediate entities in the hierarchical arrangement might be missing because they are not relevant.

The social networking system 200 further comprises the action interest extractor 120, mentioned above. The action interest extractor 120 accesses the action log 110 and extracts a set of interests and a weighting associated with each interest derived from the logged actions. The weighting or discount factors for a given interest indicate the strength of that interest as an indication of the user's current interests. The weighting may be a product of several factors. For example, the weighting may be derived from a set of discount factors that are based on a decay representative of the time associated with the action, a type of action performed, the user or connection who performed the action, one or more interests extracted based on the object on which the action was performed, and additional information related to the action (e.g., the content of a user's comment or a location). The action interest extractor 120 determines a cumulative discount factor based on each of these factors.

In the embodiment described above, a discount factor corresponding to a decay representative of the time associated with the action is used to provide temporal relevance for targeting information items. Some embodiments employ the approach of accounting for the actions in specific windows of time, and discounting or weighing the windows differently. For example, actions in the last 30 days may be associated with a discount factor of 0.5 while actions in the last 90 days may be associated with a discount factor of 0.25. Additionally, different actions on an object might indicate different levels of affinity (or lack thereof). Joining a group associated with an object might indicate a higher factor than merely “liking” the same object. Similarly, “leaving” a page might indicate a low discount factor.

The action interest extractor 120 may consult the taxonomy 218 to obtain additional interests associated with an interest that has been extracted based on an action. The taxonomy 218 thus enables the action interest extractor 120 to obtain more interests associated with a user's current state of mind, thereby increasing the effectiveness of the fuzzy matcher 150. However, the additional inferred interests obtained using the taxonomy may be discounted more as their meaning departs from the originally extracted interest.

In some embodiments, the action interest extractor 120 extracts interests from the logged actions of the connections of a user in addition to those of the user. The action interest extractor 120 may consult the affinity predictor 216 to determine a friend factor discount based on the rank or closeness of a relationship. As the connection of a user becomes more distant, the extracted interests associated with that connection's action may be discounted more heavily.

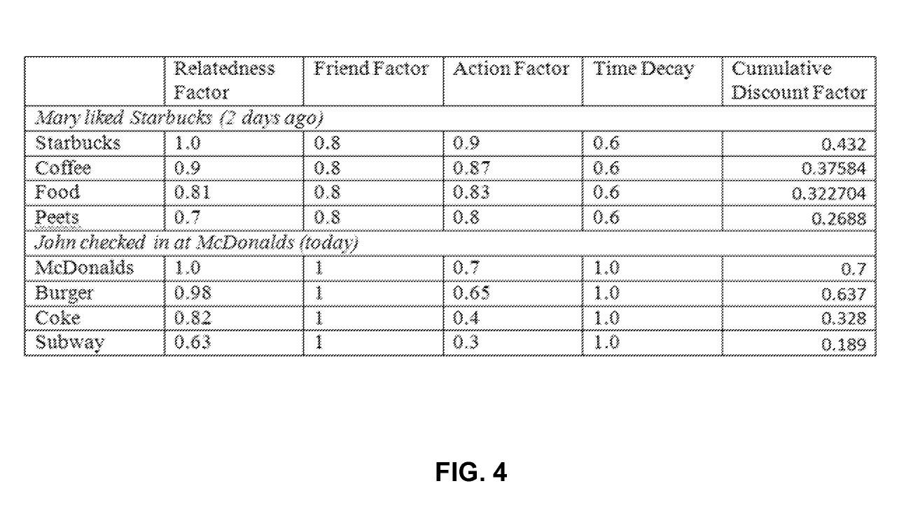

FIG. 4 is a table of a set of example interests and their associated cumulative discount factors determined for representing a user's inferred interests. John is the user of the social networking system 200 for whom the action interest extractor 120 is applied. The action interest extractor 120 analyzes the action of Mary, a connection of John, where the action “Mary liked Starbucks” occurred two days ago. In this example, Mary is a reasonably strong connection of John; hence, the action interest extractor 120 determines a friend factor of 0.8 for her action. It also determines that a time decay factor of 0.6. Using the taxonomy 218, action interest extractor 120 determines that there are four additional interests—Starbucks, Coffee, Food, and Peets—with associated relatedness factors. For each interest, an action factor is assigned, based on the type of action, which in the example of FIG. 4 is “liked,” and its relevance to the interest. In some embodiments, the friend factor and time decay may also be determined differently for each interest. Based on the factors, a cumulative discount factor is determined for each interest. In one embodiment, the cumulative discount factor for an interest is obtained by multiplying the relatedness factor, action factor, friend factor, and time decay factor for the interest. A similar process may be carried for the second example in FIG. 4 for the action, “John checked in at McDonalds.” In this example, the friend factor is set to unity (i.e., no discounting) because it is the user himself who performed the action as opposed to a connection of the user.

The action interest extractor 120 may be modified in other embodiments of the invention that provide targeting for other information items, such as updates for a user's newsfeed. For example, in an embodiment, the action interest extractor 120 may not extract interests from the actions of the connections of a user as described in the newsfeed.

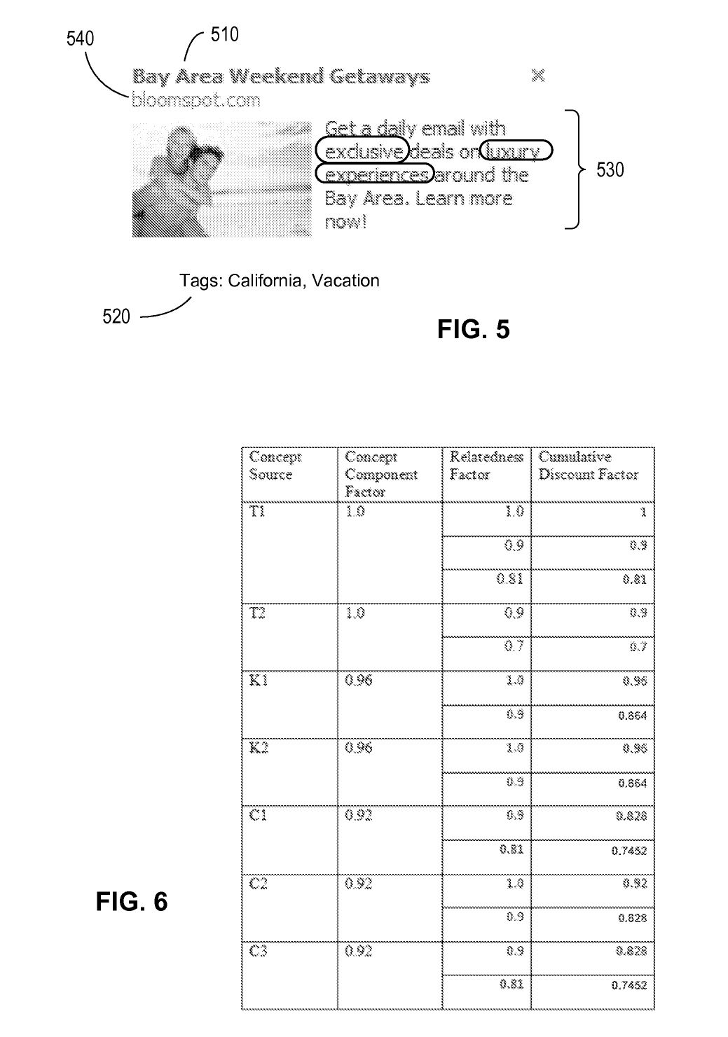

The information item concept extractor 140 uses a similar process to obtain concepts for each of a set of information items and weightings associated with each concept. The information items comprise advertisements in the examples above, and FIG. 5 illustrates an example of a typical advertisement. An advertisement may have multiple components from which to extract concepts. In the embodiment of FIG. 5, the components comprise the title of the advertisement 510, tags associated with the advertisement 520, content of the advertisement 530, and a URL linked to by the advertisement 540. Other embodiments may have more or fewer components or components similar to those shown in FIG. 5.

In the example of FIG. 5, the concepts extracted from the title of the advertisement are “Bay Area” (K1) and “Weekend” (K2). Likewise, the concepts extracted from the content of the advertisement are “exclusive” (C1), “luxury” (C2), and “experiences” (C3). Finally, the concepts extracted from the tags associated with the advertisement are “California” (T1) and “Vacation” (T2). Additional concepts may be extracted from the URL linked to by the advertisement, and more concepts may be extracted from the page linked to by the URL. Lastly, these concepts may be expanded upon using a taxonomy 218, as described above.

FIG. 6 is a table of a set of example concepts and their associated cumulative discount factors determined for an advertisement information item. The information item concept extractor 140, for advertisement information items in the embodiment of FIG. 6, computes a concept component factor based on the component from which the concept was derived and applies the same to the additional concepts related to the concept. A component like the title of an advertisement may have a higher concept component factor than, for example, the content of an advertisement.

The information item concept extractor 140 may also consult the taxonomy 218 to determine additional concepts related to the concepts derived from the advertisement and a relatedness factor associated with each additional concept. The additional entries under the “relatedness factor” column in FIG. 6 represent these additional concepts that have been obtained from the taxonomy 218, and their corresponding relatedness factors are generally lower before of the discounting that occurs when obtaining these additional concepts from the taxonomy 218, as described above.

The information item concept extractor computes a cumulative discount factor based on the concept source factor and the relatedness factor associated with each concept and additional concept. In the embodiment of FIG. 6, the cumulative discount factor is obtained by multiplying the concept source factor and the relatedness factor in each case.

The information item concept extractor 140 described above may also be used with modification in other embodiments of the invention for extracting concepts from other information items such as updates for a user's newsfeed. In the specific case of the information items being the updates for a user's newsfeed, the information item concept extractor 140 implements aspects of the action interest extractor 120 and extracts concepts from the actions of the connections of the user.

The fuzzy matcher 150, in an embodiment of the invention, implements a method for deciding the best fit between a user and a number of information items given the cumulative discount factors assigned to user interests and concepts from each of the information items. In one embodiment, the fuzzy matcher computes a score for each information item based on matching the overlapping interests and concepts from the information item and interests from the user. Specifically, the step of matching may be implemented by multiplying the corresponding cumulative discount factors for the overlapping interests and concepts and adding the results to obtain a score. The information item with the highest score thus computed is determined to be the best fit.

### Process Flow

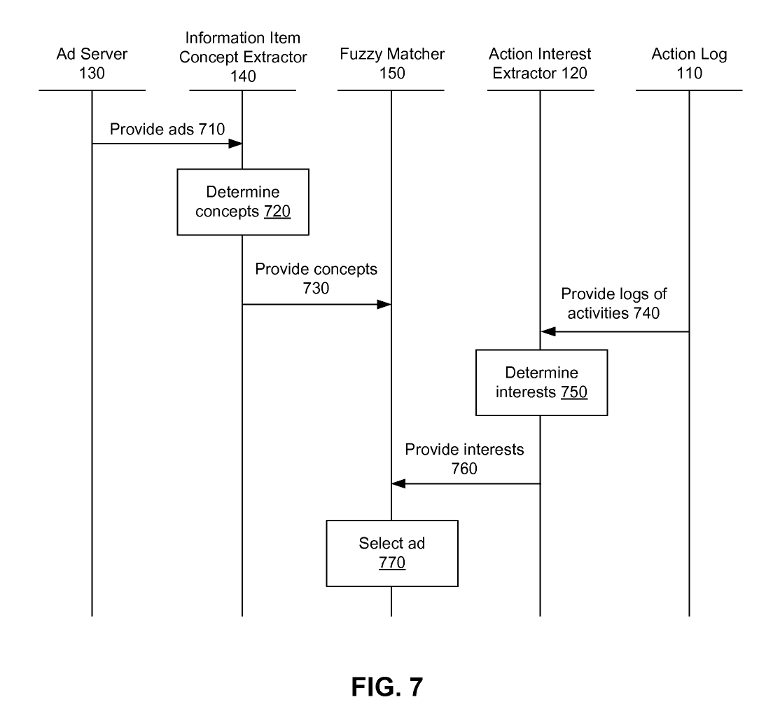

FIG. 7 illustrates a process for targeting advertisements to a user based on the inferred temporal relevance of the advertisements to the user's current interests. A similar process may apply to targeting other information items such as updates for the newsfeed displayed to the user. Additionally, it should be noted that the following description of the embodiment of the invention may be used to display advertisements to viewing users logged on the social networking system 200 directly or on the third party application 204 using the API 212.

The ad server 130 provides 710 an eligible set of advertisements to the information item concept extractor 140. The information item concept extractor 140 determines 720 the cumulative discount factor for each concept from an advertisement. The information item concept extractor 140 then provides 730 the fuzzy matcher 150 with concepts and a cumulative discount factor associated with each concept for each advertisement.

The action log 110 provides 740 logs of actions of a user to the action interest extractor 120. In some embodiments, the action log 110 also provides 740 logs of actions of the connections of the user to the action interest extractor 120. The action interest extractor 120 determines 750 interests and a cumulative discount factor for each interest in each action before providing them to the fuzzy matcher 150. The fuzzy matcher 150 then decides 770 which advertisement to display based on 730 and 760. The step of deciding 770 the best advertisement to display may be repeated to obtain a specified number of advertisements that are best targeted to the user.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for presenting temporally relevant information to a user, the method comprising:
observing actions of a user of a social networking system;
determining a plurality of interests for the user based on the observed actions;
discounting the interests based at least in part on a time of the action from which the interest was determined;
receiving a plurality of information items for display to the user of the social networking system;
determining a plurality of concepts associated with each of a plurality of information items;
comparing the interests determined for the user with the concepts determined for each of the information items, the comparing based at least in part on the discounting;
selecting one or more of the information items to display to the user, the selecting based at least in part on the comparing; and
sending the selected information items for display to the user.

2. The method of claim 1, further comprising:
inferring one or more additional interests from the determined interests using a taxonomy that identifies related terms; and
comparing the inferred interests with the concepts determined for each of the information items, wherein the one or more of the information items are selected based on the comparing of the inferred additional interests.

3. The method of claim 2, further comprising:
determining a plurality of relatedness factors associated with each of the inferred additional interests based on the extent to which the inferred interest relates to a determined interest in the taxonomy; and
discounting the inferred additional interests based at least in part on the associated relatedness factors.

4. The method of claim 1, further comprising
inferring one or more additional concepts for each of the information items using a taxonomy that identifies related terms; and
comparing the interests determined for the user with the inferred additional concepts determined for each of the information items, wherein the one or more of the information items are selected based on the comparing of the inferred additional concepts.

5. The method of claim 4, further comprising
determining a plurality of relatedness factors associated with each of the additional concepts based on the extent to which an additional concept relates to a determined concept in the taxonomy; and
discounting the inferred additional concepts based at least in part on the associated relatedness factors.

6. The method of claim 1, wherein the comparing comprises computing a score for each information item, wherein the score for each information item is based on an overlap of the determined interests for the user and the determined concepts for the information item.

7. The method of claim 6, wherein the score for each information item is reduced based on the discounting of the overlapping interests and concepts.

8. The method of claim 1, wherein the information items comprise advertisements.

9. The method of claim 8, wherein the concepts are determined from an advertisement based on a set of components of the advertisement comprising at least one of: a title of the advertisement, content of the advertisement, a tag associated with the advertisement, a link to content in the advertisement, and targeting criteria for the advertisement.

10. The method of claim 1, wherein the information items comprise updates for the newsfeed displayed to the user.

11. The method of claim 1, further comprising:
observing actions of a plurality of connections of the user of a social networking system;
determining a plurality of interests for the connections of the user based on the observed actions;
discounting the interests for the connections based at least in part on a time of the action from which the interest for the plurality of connections was determined;
matching the user with each of the information items by comparing the interests for the connections of the user with the concepts for each information item; and
selecting one or more of the information items to display to the user, the selecting based in part on the matching of the user with each of the information items by comparing the interests for the connections of the user.

12. The method of claim 11, further comprising:
discounting the plurality of interests for each of the connections based at least in part on an affinity of the user for the connection.

13. The method of claim 1, further comprising:
discounting one or more of the interests based at least in part on a type of action performed in the action from which the interest was determined.

14. A system for presenting temporally relevant information to a user, comprising:
an action log containing a record of actions of a user of a social networking system;
an action interest extractor adapted to determine a plurality of interests for the user based on the observed actions and discount the interests based at least in part on a time of the action from which the interest was determined;
an information item server adapted to receive a plurality of information items;
an information item concept extractor adapted to determine a plurality of concepts associated with the information items;
a fuzzy matcher adapted to match the user with each of the information items by comparing the interests for the user with the concepts for each information item, based at least in part on a time of the action from which the interest was determined, and to select one or more of the information items to display to the user based at least in part on the matching.

15. The system of claim 14, further comprising a taxonomy for inferring one or more additional interests from the determined interests, and wherein the fuzzy matcher is further configured to compare the inferred interests with the concepts determined for each of the information items, wherein the one or more of the information items are selected based on the comparing of the inferred additional interests.

16. The system of claim 15, wherein the taxonomy provides a plurality of relatedness factors associated with each of the inferred additional interests based on the extent to which the inferred interest relates to a determined interest in the taxonomy, wherein the inferred additional interests are discounted based at least in part on the associated relatedness factors.

17. The system of claim 14, further comprising a taxonomy for inferring one or more additional concepts for each of the information items using a taxonomy that identifies related terms, and wherein the fuzzy matcher is further configured to compare the interests determined for the user with the inferred additional concepts determined for each of the information items, wherein the one or more of the information items are selected based on the comparing of the inferred additional concepts.

18. The system of claim 17, wherein the taxonomy provides a plurality of relatedness factors associated with each of the additional concepts based on the extent to which an additional concept relates to a determined concept in the taxonomy, wherein the inferred additional concepts are discounted based at least in part on the associated relatedness factors.

19. The system of claim 14, wherein the fuzzy matcher is configured to match the user with each of the information items by producing a score for each information item, wherein the score for each information item is based on an overlap of the determined interests for the user and the determined concepts for the information item.

20. The system of claim 14, wherein the information items comprise advertisements.

21. The system of claim 14, wherein:
the action log further contains actions of a plurality of connections of the user of a social networking system,
the action interest extractor is further adapted to determine a plurality of interests for the connections of the user based on the observed actions and the interests for the connections based at least in part on a time of the action from which the interest for the plurality of connections was determined, and
the fuzzy matcher is further adapted to match the user with each of the information items by comparing the interests for the connections of the user with the concepts for each information item and select one or more of the information items to display to the user, the selecting based at least in part on the matching of the user with each of the information items by comparing the interests for the connections of the user.

22. The system of claim 21, further comprising an affinity predictor adapted to discount the plurality of interests for each of the connections based at least in part on an affinity of the user for the connection.

23. A method for presenting temporally relevant information to a user, the method comprising:
receiving information describing actions of a user of a social networking system;
receiving a plurality of information items for presentation to the user of the social networking system;
matching the information items with the information describing actions of the user, wherein the matching based on information describing an action of the user is discounted based at least in part on a time of the action;
selecting an information item based at least in part on the matching; and
sending the selected information item for presentation to the user.

24. The method of claim 23, wherein the matching based on information describing an action of the user is discounted more as the action associated therewith becomes older.

25. The method of claim 23, wherein the matching based on information describing an action of the user is weighted based on a type of the actions.

26. The method of claim 23, wherein the information items comprise advertisements.
